(19) United States
(12) Patent Application Publication
(10) Pub. No.: US 2019/0263182 A1
(43) Pub. Date: Aug. 29, 2019

(54) Aircraft Tire Crown Reinforcement

(71) Applicant: COMPAGNIE GENERALE DES ETABLISSEMENTS MICHELIN, Clermont-Ferrand (FR)

(72) Inventors: Marc ROMERO DE LA OSA, Clermont-Ferrand Cedex 9 (CA); Didier MALIN, Clermont-Ferrand Cedex 9 (FR)

(21) Appl. No.: 16/344,267

(22) PCT Filed: Oct. 24, 2017
(86) PCT No.: PCT/FR2017/052917

§ 371 Date: Apr. 23, 2019

(30) Foreign Application Priority Data
Oct. 26, 2016 (FR) 16/60380

(51) Int. Cl. B60C 9/26; B60C 9/00; B60C 9/20; B29D 30/30

(52) U.S. Cl. CPC B60C 9/263; B60C 9/0042; B60C 9/0057; B60C 9/2003; B60C 2009/2032; B60C 2009/2035; B60C 2200/02; B60C 2009/2016; B29D 30/3035

(57) ABSTRACT

Crown reinforcement of an aircraft tire with improved mechanical strength in order to increase the burst pressure of the tire, during a standard pressure test. An aircraft tire comprises a working reinforcement made up of a strip (5) wound continuously in a zigzag, from a starting end (51) to an ending end (52), in a circumferential direction (XX′) of the tire, along a periodic curve (7) forming a non-zero angle A with the circumferential direction (XX′) of the tire and in an equatorial plane (XZ) of the tire. The starting end (51) and the ending end (52) of the strip (5) are positioned axially at a distance (DI, DF) at most equal to 0.25 times the axial width W_{T} of the working reinforcement from an axial end (E1, E2) of the working reinforcement.

The present invention relates to a tire for an aircraft and the subject thereof is, in particular, an aircraft tire crown reinforcement.

In the following text, and by convention, the circumferential, axial and radial directions refer to a direction tangential to the tread surface of the tire in the direction of rotation of the tire, to a direction parallel to the axis of rotation of the tire, and to a direction perpendicular to the axis of rotation of the tire, respectively. “Radially inside” and “radially outside” mean “closer to” and “further away from the axis of rotation of the tire”, respectively. “Axially inside” and “axially outside” mean “closer to” and “further away from the equatorial plane of the tire”, respectively, the equatorial plane of the tire being the plane passing through the middle of the tread surface of the tire and perpendicular to the axis of rotation of the tire.

In general, a tire comprises a tread intended to come into contact with the ground via a tread surface, the tread being connected by two sidewalls to two beads, the two beads being intended to provide a mechanical connection between the tire and a rim on which the tire is mounted.

A radial aircraft tire comprises more particularly a radial carcass reinforcement and a crown reinforcement, as described, for example, in the document EP 1381525.

The radial carcass reinforcement is the tire reinforcing structure that connects the two beads of the tire. The radial carcass reinforcement of an aircraft tire generally comprises at least one carcass layer, each carcass layer being made up of reinforcers, usually textile, coated in a polymeric material of the elastomer type, obtained by mixing the constituents thereof, or of the elastomeric compound type, said reinforcers being mutually parallel and forming an angle of between 80° and 100° with the circumferential direction.

The crown reinforcement is the reinforcing structure of the tire that is radially inside the tread and generally radially outside the radial carcass reinforcement. The crown reinforcement generally comprises at least one crown layer, each crown layer being made up of mutually parallel reinforcers coated in an elastomeric compound. Among the crown layers, a distinction is usually made between the working layers that make up the working reinforcement and usually comprise textile reinforcers, and the protective layers that make up the protective reinforcement and comprise metal or textile reinforcers, the protective reinforcement being disposed radially on the outside of the working reinforcement. The working reinforcement dictates the overall mechanical behaviour of the crown reinforcement, while the protective reinforcement essentially protects the working layers from attack likely to spread through the tread radially towards the inside of the tire.

In the technical field of tires for aircraft, the textile reinforcers of the carcass layers and of the crown layers are usually made up of spun filaments, preferably made of aliphatic polyamide or of aromatic polyamide. The metal reinforcers potentially used in the protective layer are cords made up of metal threads.

During the manufacture of an aircraft tire and, more specifically, during the step of placing the working reinforcement, a working layer is usually obtained by circumferentially winding a strip continuously in a zigzag on a cylindrical laying surface having as its axis of revolution the axis of rotation of the tire. The strip is generally made up of at least one continuous textile reinforcer coated in an elastomeric compound and, usually, of a juxtaposition of mutually parallel textile reinforcers. The working layer is then made up of the juxtaposition of portions of strip.

Winding a strip circumferentially in a zigzag is understood to mean that the strip is wound, in the circumferential direction, along a periodic curve, i.e. a curve made up of periodic undulations oscillating between extrema. Winding a strip along a periodic curve means that the mid-line of the strip, equidistant from the edges of the strip, coincides with the periodic curve. While a strip is being wound circumferentially in a zigzag, the working layers are laid in pairs, each pair of working layers constituting a working bi-ply. Thus, a working bi-ply is made up, in its main section, that is to say axially inside the axial ends thereof, of two radially superposed working layers. At its axial ends, a working bi-ply generally comprises more than two radially superposed working layers. The axial end portion of a working bi-ply comprising more than two radially superposed working layers is referred to as the axial end overthickness. This axial end overthickness is generated by the crossings of the strip, at the end of the working bi-ply, for each turn of winding in a zigzag. Such a working reinforcement comprising working bi-plies obtained by winding a strip circumferentially in a zigzag has been described in documents EP 0540303, EP 0850787, EP 1163120 and EP 1518666.

Generally, the circumferential winding of the strip in a zigzag starts and ends at the equatorial plane of the tire, which is the circumferential plane passing through the middle of the working reinforcement and perpendicular to the axis of rotation of the tire. Consequently, the ends of strip reinforcers are positioned at the centre of the working reinforcement and thus axially on the inside of the axial ends of the working reinforcement, this being a highly mechanically stressed zone in which the reinforcer ends, which do not bear load, could create weak points in the structure and reduce the burst pressure potential of the working reinforcement.

However, the inventors have found that the positioning of the ends of strip reinforcers in the middle was a point of weakness with regard to the mechanical strength of the working reinforcement during burst pressure tests of the tire using water, in accordance with standard TSO C62-e. This is because the working reinforcement is the breaking element of the tire during the burst pressure tests.

In order to increase the mechanical strength of the working reinforcement, it is known practice to increase the number of working layers and/or to choose working layer reinforcers that have a higher breaking strength.

The inventors have set themselves the objective of increasing the mechanical strength of the working reinforcement of an aircraft tire, and thus of increasing the burst pressure of the tire, during a standard pressure test, without modifying the design of the working reinforcement in terms of the number of working layers and/or the choice of working layer reinforcers and/or the angles of the working layer reinforcers.

This objective has been achieved, according to the invention, by a tire for an aircraft, comprising:
a working reinforcement radially inside a tread and radially outside a carcass reinforcement,
the working reinforcement being axially bounded by two axial ends, spaced apart by an axial width W_{T}, and comprising at least two radially superposed working layers,
each working layer being made up of a juxtaposition of portions of a strip of width W,
the strip being wound continuously in a zigzag, from a starting end to an ending end, in a circumferential direction of the tire, over a cylindrical surface having as its axis of revolution the axis of rotation of the tire, and along a periodic curve forming a non-zero angle A with the circumferential direction of the tire and in an equatorial plane of the tire,
the starting end and the ending end of the strip being positioned axially at a distance at most equal to 0.25 times the axial width W_{T} of the working reinforcement from an axial end of the working reinforcement.

The working reinforcement of a prior art aircraft tire comprises generally at least two radially superposed working layers constituting a working bi-ply. More specifically, a working bi-ply comprises two working layers in the main section, axially inside the axial end overthicknesses, and more than two working layers at the axial end overthicknesses.

A working bi-ply is generally made up of a continuous circumferential winding in a zigzag of a strip of width W, from a starting end to an ending end. This winding is carried out in a circumferential direction of the tire, over a cylindrical surface, also known as the layer surface of radius R, having as its axis of revolution the axis of rotation of the tire. Moreover, the winding is carried out along a periodic curve, corresponding to the mid-line of the strip, forming a non-zero angle A with the circumferential direction of the tire. More specifically, the working bi-ply is made by the winding of a number N of periods of circumferential length P of the periodic curve over a number T of winding turns, that is to say a number T of circumferences 2ΠR of the cylindrical laying surface of radius R, this being expressed by the relationship N*P=T*2ΠR.

Each working layer is thus made up of a juxtaposition of portions of a strip of width W, in the circumferential direction of the tire. Two consecutive strip portions are juxtaposed in the circumferential direction, that is to say in contiguous contact with one another. In other words, two consecutive strip portions are neither separated nor partially superposed. Their respective mid-lines are borne by the periodic curve along which the strip is wound, and thus have extrema which correspond to the axial ends of the working layer.

Since the working reinforcement is a radial superposition of working layers that do not necessarily have the same axial width, the axial ends of the working layer having the greatest axial width are referred to as the axial ends of the working reinforcement. Consequently, the axial width W_{T} of the working reinforcement is equal to the maximum axial width of the working layer.

According to the invention, the starting end and the ending end of the strip are positioned axially at a distance at most equal to 0.25 times the axial width W_{T} of the working reinforcement from an axial end of the working reinforcement.

In other words, each strip starting end or ending end is positioned axially on the inside of one of the two lateral portions of the working reinforcement having an axial width equal to a quarter of the axial width W_{T} of the working reinforcement, that is to say axially on the outside of a median portion of the working reinforcement having an axial width equal to half the axial width W_{T} of the working reinforcement.

This positioning of the strip starting end and ending end makes it possible to leave the zone of maximum tensile stresses, under the action of the inflation pressure, thereby making it possible to increase the mechanical strength of the working reinforcement and, correspondingly, the burst pressure of the tire.

Advantageously, the starting end and the ending end of the strip are positioned axially at a distance at most equal to 0.1 times the axial width W_{T} of the working reinforcement from an axial end of the working reinforcement.

This positioning is a compromise that makes it possible to be as close as possible to an axial end of the working reinforcement, that is to say as far as possible from the median portion of the working reinforcement, while avoiding the axial end overthickness generated by the crossings of the strip, at the end of the working bi-ply, for each turn of winding in a zigzag, this overthickness being a mechanically stressed zone.

Preferably, the starting end and the ending end of the strip are positioned axially at a distance at least equal to 0.05 times the axial width W_{T} of the working reinforcement from an axial end of the working reinforcement.

This positioning at a minimum axial distance from an axial end of the working reinforcement makes it possible to avoid the axial end overthickness generated by the crossings of the strip, at the end of the working bi-ply, for each turn of winding in a zigzag, this overthickness being a mechanically stressed zone. Thus, the starting end and ending end of the strip, which are likely points for crack initiation, are positioned axially outside the zones of high mechanical stresses generated by the crushing of the tire on the ground, thereby improving the endurance of the crown reinforcement.

According to a first embodiment variant of the invention, the starting end and ending end of the strip are positioned axially from the same axial end of the working reinforcement, that is to say that the two ends of the strip are positioned on the same side with respect to the equatorial plane.

This first embodiment variant makes it possible to optimize the length of strip laid and to avoid a local overthickness resulting from a superposition of strip portions in the rectilinear portions of the path of the strip.

According to a second embodiment variant of the invention, the starting end and ending end of the strip are positioned axially from the two different axial ends of the working reinforcement, that is to say that the two ends of the strip are positioned on opposite sides with respect to the equatorial plane.

This second embodiment variant allows greater tolerance in axial positioning of the starting end and ending end of the strip during manufacture and thus makes it easier to manufacture the working reinforcement, notably for tires of small size, for example those intended to be mounted on a rim with a nominal diameter at most equal to 15 inches.

According to a preferred embodiment variant of the invention, the starting end and ending end of the strip are positioned axially at an identical distance.

This preferred embodiment variant ensures a constant thickness of the working reinforcement in the rectilinear portions of the path of the strip, locally avoiding overthicknesses or holes.

The angle A formed by the periodic curve with the circumferential direction of the tire and in the equatorial plane of the tire is further advantageously at least equal to 5°. A minimum angle A of 5° ensures a minimum cornering stiffness for the tire.

The angle A formed by the periodic curve with the circumferential direction of the tire and in the equatorial plane of the tire is also advantageously at most equal to 20°. Above an angle A equal to 20°, the cornering stiffness of the aircraft tire becomes too high for the desired performance.

The width W of the strip is advantageously at least equal to 2 mm, preferably at least equal to 6 mm. A minimum strip width value is necessary both for the technological feasibility of the strip and for the productivity of laying of the strip.

The width W of the strip is further advantageously at most equal to 20 mm, preferably at most equal to 14 mm. A maximum strip width value makes it possible to reduce the number of turns over which the strip is laid in a zigzag that are needed to create the working bi-ply, thereby reducing the time needed to create the working bi-ply and therefore increasing productivity.

With the strip being made up of reinforcers coated in an elastomeric compound, the strip comprises, according to a first embodiment variant of the reinforcers, reinforcers made of a textile material, preferably of an aliphatic polyamide. Specifically, textile reinforcers, particularly made of aliphatic polyamide such as nylon, have a relatively low mass compared with metal reinforcers, thereby allowing a significant saving on the mass of the tire and therefore a gain in the payload that the aircraft can carry.

With the strip being made up of reinforcers coated in an elastomeric compound, the strip comprises, according to a second embodiment variant of the reinforcers, reinforcers made of an aromatic polyamide. Specifically, reinforcers made of aromatic polyamide, such as aramid, make it possible to achieve a good compromise between high mechanical strength and low weight.

With the strip being made up of reinforcers coated in an elastomeric compound, the strip comprises, according to a third embodiment variant of the reinforcers, hybrid reinforcers made of a combination of an aliphatic polyamide and an aromatic polyamide. Such reinforcers are usually referred to as hybrid reinforcers and offer the technical advantages of nylon and of aramid: high mechanical strength, high tensile deformability and low weight.

The invention also relates to a method for manufacturing an aircraft tire, comprising a step of manufacturing the working reinforcement, wherein the strip is wound continuously in a zigzag, from a starting end to an ending end, in the circumferential direction of the tire, onto a cylindrical surface, having as its axis of revolution the axis of rotation of the tire, and along a periodic curve forming a non-zero angle A with the circumferential direction of the tire and in the equatorial plane of the tire, such that the starting end and the ending end of the strip are positioned axially at a distance at most equal to 0.25 times the axial width W_{T} of the working reinforcement from an axial end of the working reinforcement.

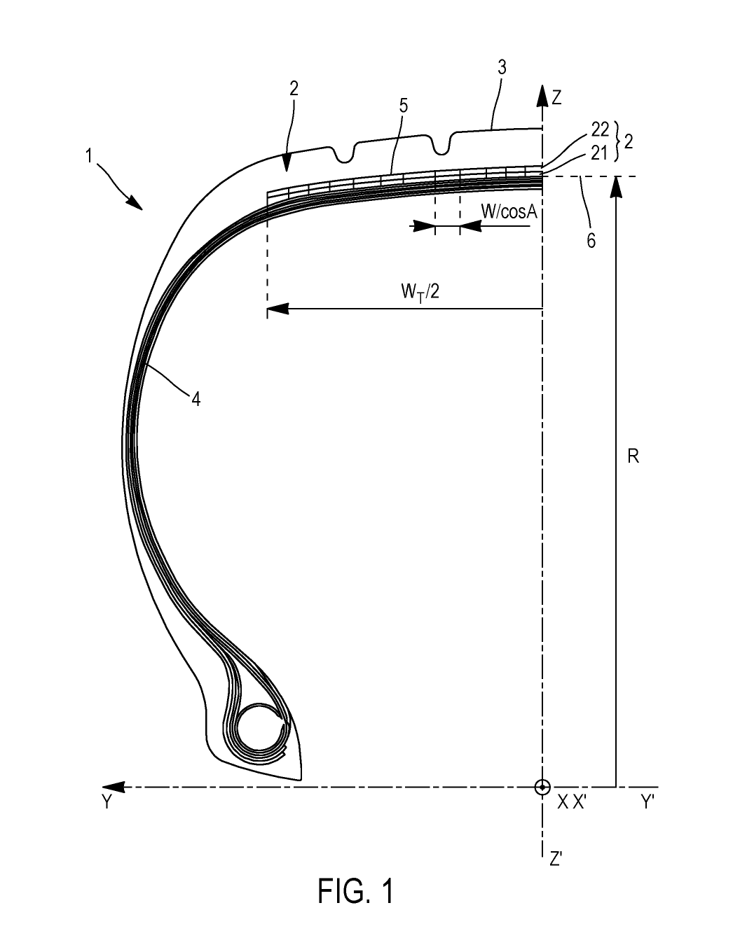

The features and other advantages of the invention will be better understood with the aid of the following FIGS. 1 to 5, which have not been drawn to scale:

FIG. 1: a half-view in section of an aircraft tire according to the invention, in a meridian or radial plane (YZ) passing through the axis of rotation (YY′) of the tire.

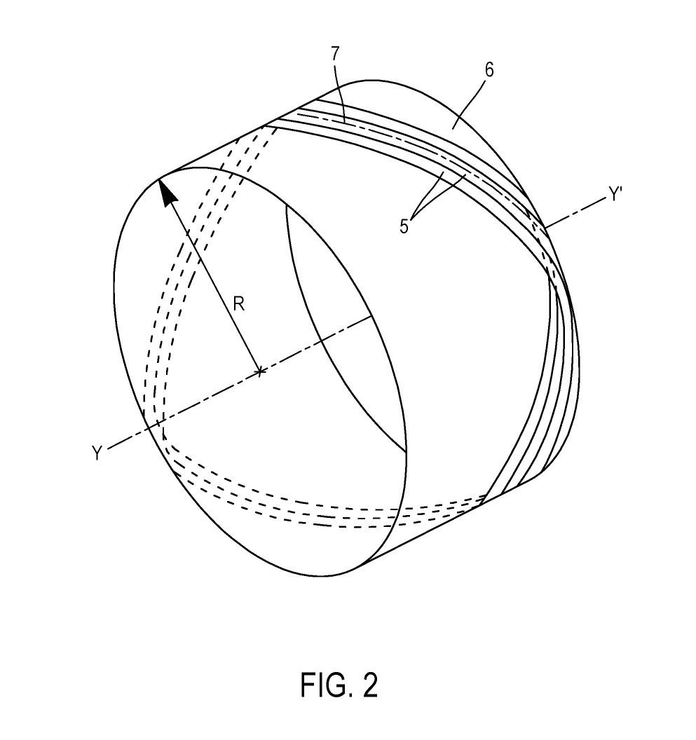

FIG. 2: a perspective view of a strip circumferentially wound in a zigzag, along a periodic curve, over a cylindrical surface.

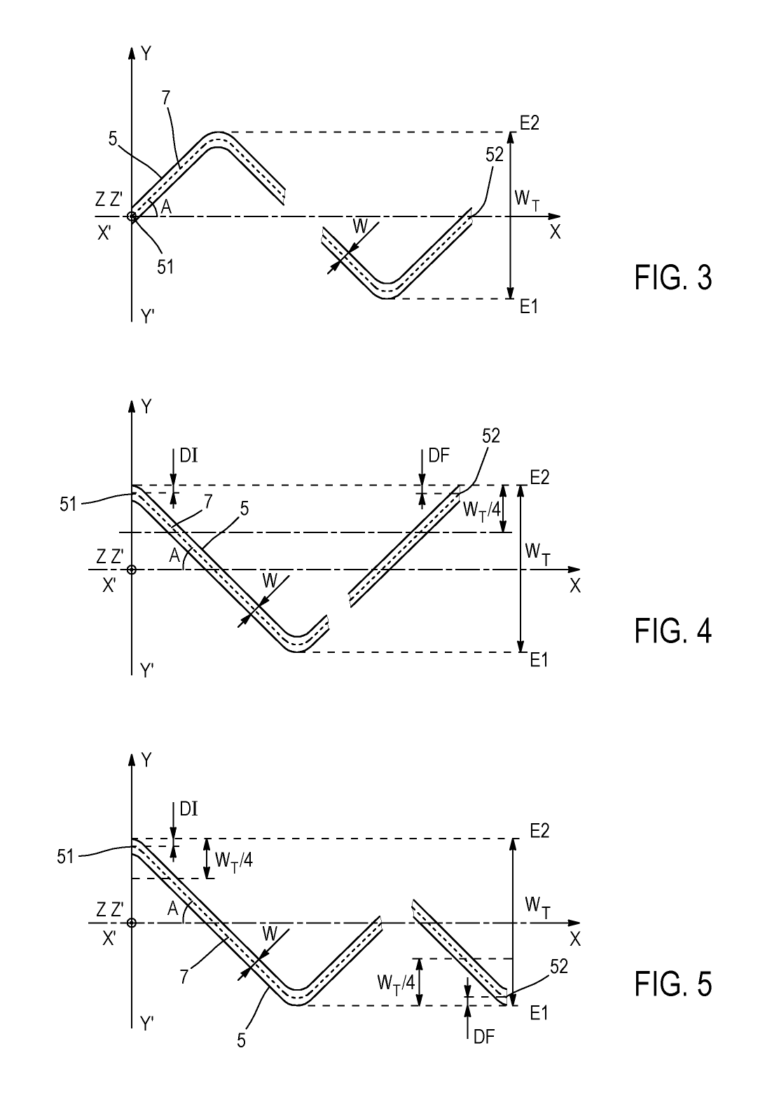

FIG. 3: a developed view of a strip circumferentially wound in a zigzag, with the starting end and ending end of the strip positioned in the equatorial plane of the tire, according to the prior art.

FIG. 4: a developed view of a strip circumferentially wound in a zigzag, with the starting end and ending end of the strip positioned on one and the same side of the equatorial plane of the tire, according to a first embodiment variant of the invention.

FIG. 5: a developed view of a strip circumferentially wound in a zigzag, with the starting end and ending end of the strip positioned on either side of the equatorial plane of the tire, according to a second embodiment variant of the invention.

FIG. 1 shows a half-view in section, in a radial plane (YZ), of a prior art aircraft tire 1, comprising a working reinforcement 2 radially inside a tread 3 and radially outside a carcass reinforcement 4. In the example shown, the working reinforcement 2 comprises a working bi-ply made up of two radially superposed working layers (21, 22) and obtained by circumferentially winding (see FIG. 2) a strip of width W in a zigzag over a cylindrical laying surface 6 of radius R, having as its axis of revolution the axis of rotation (YY′) of the tire. The axial end overthicknesses of the working bi-ply 21 are not shown for the sake of simplicity. In a radial plane, each working layer (21, 22) is made up of an axial juxtaposition of strip portions 5 of width W/cos A, where W is the width of the strip 5, measured perpendicularly to its mid-line, and A is the angle (see FIG. 3) formed by the mid-line of the strip 5 with the circumferential direction (XX′) in the equatorial plane (XZ). Since the width of the working reinforcement is equal to W_{T}, its half-width W_{T}/2 is shown in FIG. 1.

FIG. 2 is a perspective view of a strip 5 that makes up a working reinforcement of a prior art tire, wound circumferentially in a zigzag, along a periodic curve 7, over a cylindrical laying surface 6, which is rotationally symmetrical about the axis of rotation (YY′) of the tire, having a radius R. Only three winding turns of the strip 5 are shown in FIG. 2, that is to say one working layer in the course of being produced.

FIG. 3 is a developed view showing the start and end of winding of a strip 5 having a width W in a zigzag, the mid-line 7 of said strip 5 forming an angle A with the circumferential direction XX′ and in the equatorial plane XZ, the intermediate part of the winding not being shown here. The amplitude of the zigzag defines the axial width W_{T} of the working reinforcement, that is to say the axial distance between the two axial ends E1 and E2 of the working reinforcement. The prior art winding, shown in FIG. 3, is characterized by the strip starting end and ending end being positioned in the equatorial plane XZ, it being possible for this to be more generally in the vicinity of the equatorial plane XZ.

FIG. 4 is a developed view showing the start and end of winding of a strip 5 in a zigzag, according to a first embodiment variant of the invention. In this case, the starting end 51 and the ending end 52 of the strip 5 are positioned axially at respective distances DI and DF at most equal to 0.25 times the axial width W_{T} of the working reinforcement from the same axial end E2 of the working reinforcement.

FIG. 5 is a developed view showing the start and end of winding of a strip 5 in a zigzag, according to a second embodiment variant of the invention. In this case, the starting end 51 is positioned at a distance DI at most equal to 0.25 times the axial width W_{T} of the working reinforcement from the axial end E2 of the working reinforcement, and the ending end 52 is positioned at a distance DF at most equal to 0.25 times the axial width W_{T} of the working reinforcement from the opposite axial end E1 of the working reinforcement.

The inventors produced an aircraft tire of size 50x20R22 according to the prior art and according to the second embodiment variant of the invention, respectively. The tire according to the second embodiment variant of the invention is characterized by the starting end and ending end of the strip being positioned axially on either side of the equatorial plane of the tire at axial distances with respect to the axial ends of the working reinforcement that are identical and equal to DI=DF=0.1 W_{T}.

These tires were subjected to a pressure test using water according to standard TSO C62-e. The two tires burst as a result of their working reinforcement breaking. The burst pressure measured for the tire of the invention is 0.2 Pn greater than that measured for the prior art tire, Pn being the nominal inflation pressure of the tire.

1. Tire for an aircraft, comprising:
a working reinforcement radially inside a tread and radially outside a carcass reinforcement;
the working reinforcement being axially bounded by two axial ends, spaced apart by an axial width W_{T}, and comprising at least two radially superposed working layers;
each said working layer being comprised of a juxtaposition of portions of a strip of width W; and
the strip being wound continuously in a zigzag, from a starting end to an ending end, in a circumferential direction of the tire, over a cylindrical surface having as its axis of revolution the axis of rotation of the tire, and along a periodic curve forming a non-zero angle A with the circumferential direction of the tire and in an equatorial plane of the tire,
wherein the starting end and the ending end of the strip are positioned axially at a distance at most equal to 0.25 times the axial width W_{T} of the working reinforcement from an axial end of the working reinforcement.

2. The aircraft tire according to claim 1, wherein the starting end and the ending end of the strip are positioned axially at a distance at most equal to 0.1 times the axial width W_{T} of the working reinforcement from an axial end of the working reinforcement.

3. The aircraft tire according to claim 1, wherein the starting end and the ending end of the strip are positioned axially at a distance at least equal to 0.05 times the axial width W_{T} of the working reinforcement from an axial end of the working reinforcement.

4. The aircraft tire according to claim 1, wherein the starting end and ending end of the strip are positioned axially from the same axial end of the working reinforcement.

5. The aircraft tire according to claim 1, wherein the starting end and ending end of the strip are positioned axially from two different axial ends of the working reinforcement.

6. The aircraft tire according to claim 1, wherein the starting end and ending end of the strip are positioned axially at an identical distance.

7. The aircraft tire according to claim 1, wherein the angle A formed by the periodic curve with the circumferential direction of the tire and in the equatorial plane of the tire is at least equal to 5°.

8. The aircraft tire according to claim 1, wherein the angle A formed by the periodic curve with the circumferential direction of the tire and in the equatorial plane of the tire is at most equal to 20°.

9. The aircraft tire according to claim 1, wherein the width W of the strip is at least equal to 2 mm.

10. The aircraft tire according to claim 1, wherein the width W of the strip is at most equal to 20 mm.

11. The aircraft tire according to claim 1, the strip being comprised of reinforcers coated in an elastomeric compound, wherein the strip comprises reinforcers comprised of a textile material.

12. The aircraft tire according to claim 1, the strip being comprised of reinforcers coated in an elastomeric compound, wherein the strip comprises reinforcers comprised of an aromatic polyamide.

13. The aircraft tire according to claim 1, the strip being comprised of reinforcers coated in an elastomeric compound, wherein the strip comprises hybrid reinforcers comprised of a combination of an aliphatic polyamide and an aromatic polyamide.

14. Method for manufacturing an aircraft tire according to claim 1, comprising a step of manufacturing the working reinforcement, wherein the strip is wound continuously in a zigzag, from a starting end to an ending end, in the circumferential direction of the tire, onto a cylindrical laying surface of radius R, having as its axis of revolution the axis of rotation of the tire, and along a periodic curve corresponding to the mid-line of the strip and forming a non-zero angle A with the circumferential direction of the tire and in the equatorial plane of the tire, such that the starting end and the ending end of the strip are positioned axially at a distance at most equal to 0.25 times the axial width W_{T} of the working reinforcement from an axial end of the working reinforcement.

15. The aircraft tire according to claim 1, wherein the width W of the strip is at least equal to 6 mm.

16. The aircraft tire according to claim 1, wherein the width W of the strip is at most equal to 14 mm.

17. The aircraft tire according to claim 1, the strip being comprised of reinforcers coated in an elastomeric compound, wherein the strip comprises reinforcers comprised of a textile material of an aliphatic polyamide.
